(19) United States
(12) Patent Application Publication
(10) Pub. No.: US 2011/0098833 A1
(43) Pub. Date: Apr. 28, 2011

(54) Method and Apparatus for Controling Media in a Portable Communication Device

(75) Inventors: Matthew M. Seflic, Chicago, IL (US); Julio C. Castaneda, Coral Springs, FL (US); Adam Cybart, McHenry, IL (US); Matthew S. MacQueen, Chicago, IL (US)

(73) Assignee: MOTOROLA, INC., Schaumburg, IL (US)

(21) Appl. No.: 12/630,043

(22) Filed: Dec. 3, 2009

Related U.S. Application Data
(60) Provisional application No. 61/255,275, filed on Oct. 27, 2009.

(51) Int. Cl. G06F 17/00; H04B 1/38

(52) U.S. Cl. 700/94; 455/566

(57) ABSTRACT

A method and apparatus controlling a media player in a portable communication device is provided. The method includes providing a plurality of controls dedicated to controlling the media player. Each of the controls is configured in a manner that requires a unique user action for providing an input. In other words, the user action required for operating a control is different from a user action required for operating each of the other controls. The method further includes receiving a user input at each of the controls and controlling the media player based on the received user inputs. Each of the controls is operable to perform a specific function for managing media.

### FIELD OF THE DISCLOSURE

The present disclosure relates generally to controlling media and more particularly to controlling media using dedicated controls in a portable communication device.

### BACKGROUND

The number of applications and device functions provided by portable communication devices such as mobile phones increases rapidly with each generation. An increasing number of device applications and device functions results in a more complex and more sophisticated handling of the total mobile phone operation. Conventionally, such devices utilize the overall navigation paradigm to control media on the devices. For traditional mobile phones this often means users control their media using a 5-way navigation cluster having a plurality of controls, each operated to perform more than one function on the device. In order to control a media player, the navigation controls are used to navigate through a graphical and/or text based menu. In more detail, the user has to navigate through the menu by selecting adapted input means, i.e. navigation keys, to track down certain menu items provided for controlling and managing the media player. Other known techniques of controlling a media player on a portable communication device include morphing technology i.e., dynamically changing the keypad controls to focus the interaction to media when in media mode. Also, direct interaction models such as touch screens enable touch based controlling of a media player in media mode.

However, none of the above techniques provide an easy, fast, and non-mode dependent media controls that require minimum user interaction. For example, tracking of a menu requires time and in many cases, a complex menu unacceptable to users. Moreover, menu-driven interfaces require a user to look at the menu on a display while operating the controls or listen to an audio prompt in cases of a voice based menu. Such interactions require a user to be completely attentive and engaged while operating the controls, which is becoming increasingly unacceptable to modern users.

It would be considered an improvement in the art, to provide controls that minimize user distraction during operation. For example, during operation, such as exercising, bike riding, jogging, crossing a street, and the like, it would be considered an improvement if a user could easily control a media player by feel or “blindly”, without having to be distracted by looking at a display.

It would further be considered an improvement in the art, to provide a plurality of controls configured to provide a unique specific user action or signature, for each operation, for minimizing distractions.

It would further be considered an improvement in the art, to provide a plurality of controls configured to provide a unique specific user action or signature for each operation, which is intuitive to a user.

It would further be considered an improvement, to provide a plurality of controls which are accessible and located on a device, for simplified operation.

Accordingly, there is a need for a method and apparatus for controlling media in a portable communication device.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a portable communication device in accordance with some embodiments.

FIG. 2 illustrates a media control unit of the portable communication device in accordance with some embodiments.

FIG. 3 illustrates an embodiment of the invention implemented in the form of a control that is being operated in accordance with an embodiment.

FIG. 4 illustrates an embodiment of the invention implemented in the form of a control that is being operated in accordance with an embodiment.

FIG. 5 illustrates an embodiment of the invention implemented in the form of a control that is being operated in accordance with an embodiment.

FIG. 6 is a flowchart of a method of controlling media in a portable communication device in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Various embodiments of the invention disclose a method and apparatus for controlling a media player in a portable communication device. The method includes providing a plurality of controls dedicated to controlling the media player. Each of the controls is configured in a manner that requires a unique user action for providing an input. In other words, the user action required for operating a control is different from a user action required for operating each of the other controls. The method further includes receiving a user input at each of the controls and controlling the media player based on the received user inputs. Each of the controls is operable to perform a specific function for managing media.

A portable communication device includes a media control unit for controlling a media player. The media control unit includes a plurality of controls dedicated to controlling the media player by receiving user inputs. Each of the controls is configured so as to require a user action for activating the control, the user action being different from a user action required for activating each of the other controls. Further, each of the plurality of controls performs a specific function for managing media. The portable communication device further includes a processor for receiving control signals from the media control unit and controlling the media player.

Before describing in detail the method for controlling a media player in a portable communication device, it should be observed that the present invention resides primarily in combinations of method steps and apparatus components related to controlling a media player in a portable communication device. Accordingly, the method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

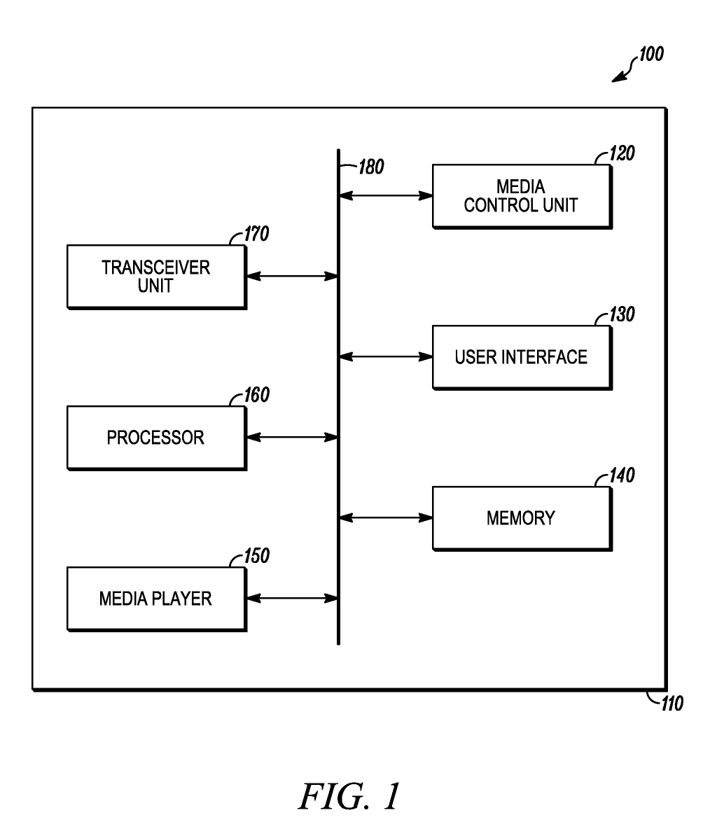

FIG. 1 is a block diagram of a portable communication device (PCD) in accordance with some embodiments. The display device includes a media control unit 120, user interface 130, memory 140, media player 150, processor 160, and a transceiver unit 170, each capable of communicating with one or more other components of the portable communication device. For example, as shown in FIG. 1, all components are coupled to a bidirectional system bus 180 and enclosed within a housing 110 of the PCD 100. Examples of the portable communication device 110 include personal digital assistants (PDAs), handheld computing devices, cell phones, and the like.

The user interface 130 directs user input data to the processor 160 and represents input devices and output devices for interfacing with a user. The input devices are used for receiving user inputs to the PCD 100 and communicating the user inputs to the processor. The input devices may generate key input data from commands entered by a user to control various operations of the PCD 100. The input devices allow the user to enter various types of information, and may include a keypad, a dome switch, a touch pad (e.g., a touch sensitive member that detects changes in resistance, pressure, capacitance, etc. due to contact), a jog wheel, a jog switch, and the like. In particular, when the touch pad is overlaid on the display in a layered manner, it may form a touch screen. The output devices render information to the user, and may include a printer, a speaker, a monitor, and the like.

The processor 160 (such as a microprocessor or the like) typically controls the general operations of the PCD 100. For example, the processor 160 performs controlling and processing associated with computation, communication, transaction, and the like. The memory 140 may store software programs or the like used for the processing and controlling operations performed by the processor 160, or may temporarily store data (e.g., a phonebook, messages, still images, video, etc.) that have been inputted or which are to be outputted. For example, the memory 140 stores the graphic user interface (GUI) program that contains the commands for presenting information on a display. The memory 140 may include at least one type of storage medium including a Flash memory, a hard disk, a multimedia card, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disk, an optical disk, and the like.

The transceiver unit 170 can be implemented as a transmitting and receiving component of the PCD 100. In an embodiment, the functions of the transceiver 170 can be implemented in the processor 160. The transceiver unit 170 makes content available to the PCD 100 over an antenna (not shown). The antenna includes any known or developed structure for radiating and receiving electromagnetic energy in the frequency range containing the wireless carrier frequencies.

The media player 150 is configured to provide an interface to a user to allow the user to control and interact with the media player. The term “media player” as used herein refers to an application that allows one or more types of media to be viewed and/or played by a user. The media player 150 includes a control program stored in the memory 140, for media playback and automatic selection of media items from a plurality of media items stored in a database in memory. The media player 150 may also, for example, perform the automatic population of play lists and/or the automatic re-ordering of play lists. The control program also processes playlists, playing songs and/or displaying images in accordance with the sequential requirements of one or more play lists stored in memory 140. The control program also manages the downloading of new media items into a database of the media player 150.

The processor may also be configured to perform the various embodiments described herein. For example, the processor is operative to monitor the media control unit 120 by receiving the associated input signals from the user. Based upon the characteristics of input signals received from the media control unit 120 the processor determines whether or not the user has imparted a user action to operate upon the media player 150.

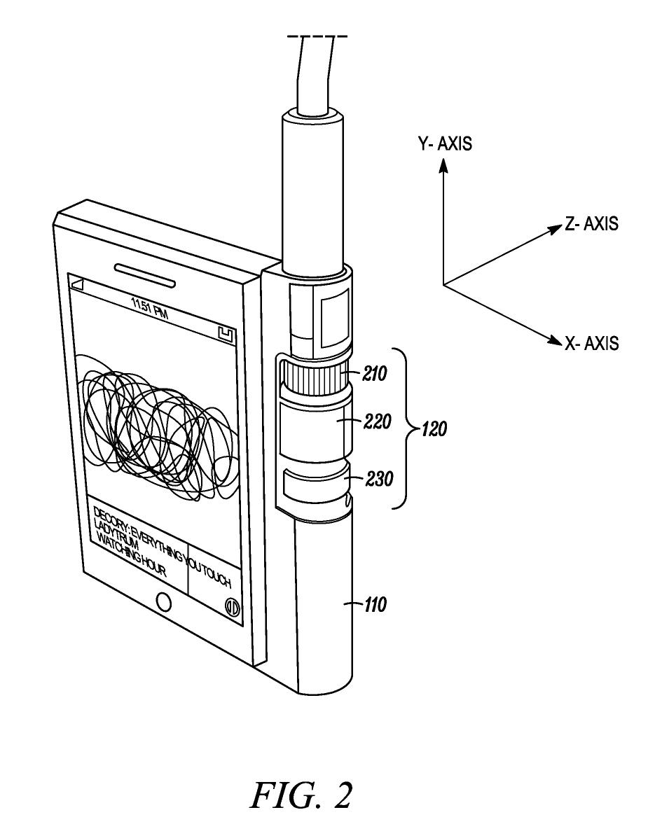

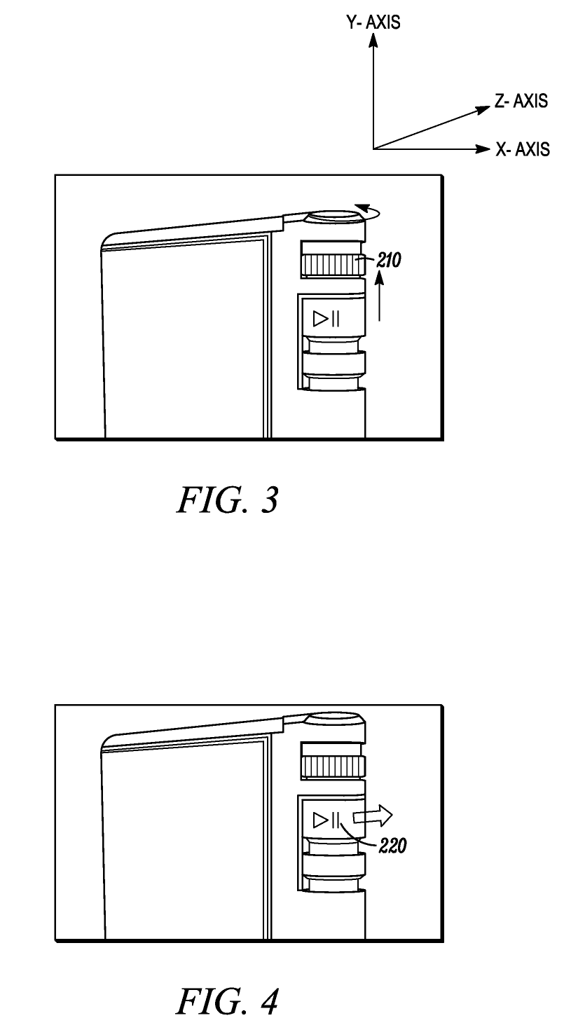

FIG. 2 shows a media control unit of the portable communication device in accordance with an embodiment. The media control unit 120 includes a plurality of controls 210, 220, 230 dedicated to controlling the media player 150 by receiving user inputs. Here the term “control” refers to a physical component, the mechanism of which causes an operation on the media player 150. Here the term “dedicated” refers to a control being set apart to perform a single function. Examples of a control (210, 220, or 230) include a push button, rotary knob, joystick, switch, a rocker pad or touch pad. Another possibility is that the input controls include a light sensor, an electromagnetic sensor, a pressure and/or temperature sensor capable of detecting physiological responses, any other now known or later developed sensor capable of detecting physiological responses, or combinations thereof. The media control unit 120 is coupled to the housing 110 of the PCD 100 in a location suitable for a user of the PCD 100 to operate and thereby activate the controls 210, 220, 230. In an embodiment as shown in the figure, the media control unit 120 is located on a lateral side of the housing 110 so as to facilitate easy and quick location of controls 210, 220, 230 by the user. Lateral side refers to one of the planes that form the housing 110 apart from the front and rear planes of the housing 110. The housing 110 can have a clamshell form, a candy-bar form, or a slider form. The media control unit 120 can be located on a hinge of a clamshell form PCD 100. Each of the plurality of controls (210, 220, or 230) is configured or articulated so as to require a user action (for operating the control) which is different from a user action required for operating each of the other controls (210, 220, or 230). Further, each control (210, 220, or 230) in the media control unit 120 is operable to perform a specific function for managing media. This results in a clear interaction for the user that is not dependent upon activating a media mode on the PCD 100. Furthermore, each individual control (210, 220, or 230) has a unique movement that enables blind interaction i.e., the user does not have to focus on the controls 210, 220, and 230 while operating the controls 210, 220, 230. For example, while running/exercising the user does not have to look at control (210, 220, or 230) or listen to an audio guide in order to manage media. This is possible because of the uniqueness of operating each control (210, 220, or 230), where each control (210, 220, or 230) is dedicated to performing a specific function. Examples of such functions include play, pause, stop, skip, fast forward, rewind, volume control, shuffle, etc. In an example embodiment, as shown in FIGS. 3-4, the media control unit 120 includes multiple controls dedicated to controlling media e.g., audio files. The media control unit 120 acts as an interface for a user to control a music player for managing audio files. The controls are configured (or adapted) to provide core functionalities of the media application. In this example of the music player application, this primary functionality could be playing audio files in a play list. Thus, one of the controls provides a play function to begin playing the audio files. The one or more other controls are configured to be assigned unique functionalities consistent with the core functions of the particular application that is presently being interacted with. The media control unit 120 receives user input through each of its controls 210, 220, 230 and translates the user input into input signals. The input signals are received by the processor 160 and processed to generate control instructions for controlling the media player 150.

Advantageously, the portable communication device 100 provides a media control unit 120, which solves a problem of user distraction during operation. For example, while exercising, bike riding, jogging, crossing a street, and the like, a user can easily and intuitively control the media control unit 120, by feel or “blindly”, without having to be distracted by looking at a display.

Further, the media control unit 120 advantageously provides a unique specific user action, signature or gesture, for each separate operation, for enhanced blind operation and user experience. In a preferred embodiment, the user actions or gestures are intuitive.

The media control unit 120 is particularly adapted to be accessible, in a blind application, such as when located in a user's exercising holster or pocket, and the media control unit 120 is located and accessible to a user, for simplified operation, as detailed herein.

As shown in FIG. 3, the first control 210 is a rotary band which the user operates by rotating around a vertical axis (Y-axis) of rotation. The first control 210 is dedicated to performing a specific function e.g., for controlling volume of audio files being played. In an embodiment, the rotary band 210 may be in a locked position to prevent accidental or unintended rotation of the band 210 and needs to be unlocked prior to operation. For example, the rotary band 210 is initially in a locked position where the band 210 is either non-rotatable or is rotatable but does not detect a rotation as an input. In order to unlock the rotary band 210 for operation, the band 210 is moved up along the vertical axis. In the unlocked position, a rotation of the band 210 in a given direction is translated into an input signal for controlling volume of the audio file being played. In an embodiment, the rotary band 210 is spring loaded such that, operating the band 210 requires moving the band 210 up along the vertical axis for unlocking, and then rotating the band 210 for volume control. Upon releasing the band 210 i.e., upon terminating the user action on the band 210, the band 210 snaps back to self-lock in its initial position.

The second control 220, as shown in FIG. 4, is a push button which the user operates by pressing the button along optical axis (Z-axis). The second control 220 is dedicated to perform a specific function of playing or pausing an audio file. The second control 220 is operated by pressing the button for playing the media file. The push button 220 remains in the depressed position while playing the audio file. For performing a pause function, the push button is pressed again and the button 220 springs back to its initial (non-depressed) position. In an embodiment, pressing the button 220 to a first depressed position constitutes a play operation and pressing the button 220 again to a second depressed position constitutes a pause operation. When the button 220 is pressed again while in the second depressed position, the button 220 springs back to the initial non-operative position.

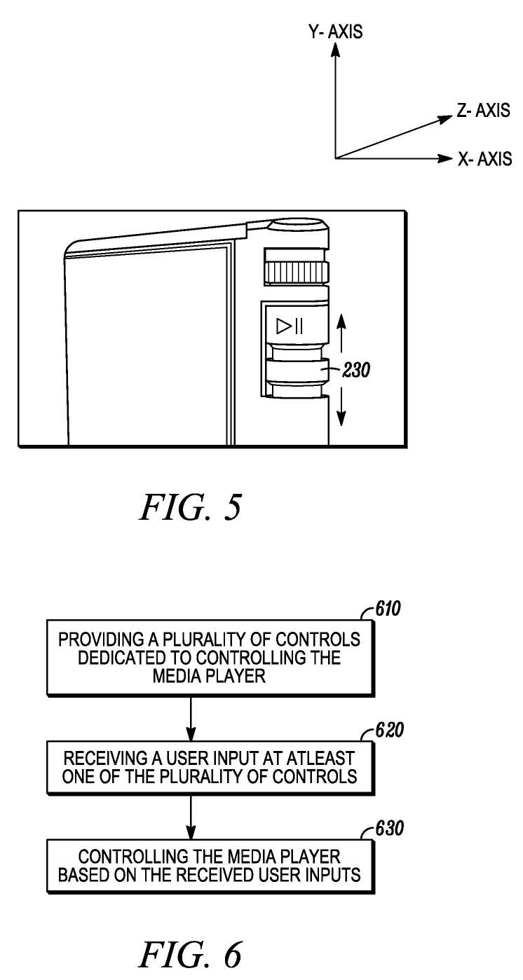

The third control 230, as shown in FIG. 5, is a spring loaded ring movable along the vertical axis from a neutral position. The third control 230 is dedicated to skipping over audio files. The ring 230 is initially in a neutral position and slides up or down over a cylindrical frame from the neutral position in response to a user operation. In order to skip an audio file(s) and move forward through a play-list of audio files, the ring 230 is moved upward from the neutral position by means of a user action. For example, the user can slide the ring using his/her thumb. Once the user action is terminated, the ring 230 snaps back to the neutral position. Similarly, in order to skip an audio file and move backward through the play-list of audio files, the ring 230 is moved downward from the neutral position. Once the ring 230 is released from the downward position, the ring 230 snaps back to the neutral or no-operation position. In this example of the media control unit, all the three controls are built around a barrel like (cylindrical) geometry to focus the user operation on the controls around the barrel.

In an embodiment, the media control 120 unit may have an arrangement for locking the controls 210, 220, 230 from operation in certain environments. For example, the media control unit 120 can include a sensor arrangement for detecting whether the PCD 100 as a whole is in motion, such as while the PCD 100 is with a user who is walking or jogging. In the event, the sensor arrangement detects that the PCD 100 is in an environment that may cause unintended operation (false user action) on the media control unit 120, a locking signal is provided by the sensor arrangement. Based on the locking signal, the processor 160 locks the controls from being operation. The media control unit 120 can be locked by either making the controls immobile or by configuring the controls to be unresponsive to an operation. Examples of the sensor arrangement include, pressure sensor, accelerometer based sensor, capacitive sensors etc.

FIG. 6 is a flowchart depicting a method of controlling media in a portable communication device according to an embodiment. The method includes providing 610 a plurality of controls dedicated to controlling a media player in the portable communication device. Here providing refers to locating the controls on the portable communication device. The plurality of controls are embodied as dedicated physical components for receiving user inputs. The plurality of controls are co-located on a common housing on the PCD 100 to form a single dedicated unit for controlling a media player on the PCD 100. Here the term “co-located” refers to being placed side by side. The media player is one of an audio player, a video player, or both. Each of the plurality of controls is configured to operate based on a user action for providing an input, which is different from a user action required by each of the other controls for providing an input. For example, each control operates based on one of a rotating mechanism, a sliding mechanism, a push button mechanism, or a switching mechanism. Each of the controls receives 620 a user input to perform a specific function for managing media and control 630 the media player based on the received user inputs. Examples of a user action required for operating each of the controls includes rotating, sliding, or pressing the control. Some functions necessary for managing media include play, pause, skip-forward, skip-backward, volume control, rewind, fast-forward, shuffle etc. Dedicated Music Controls are direct and specific to individual functions. For example, volume only controls volume and skip only skips the media forward or backward. This results in a clear interaction for the user that is not dependent upon mode. Further, each control having a unique movement enables blind interaction by the user.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed. It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A media control unit for controlling a media player in a portable communication device, the media control unit comprising:
a plurality of controls dedicated to controlling the media player by receiving user inputs,
wherein each of the plurality of controls is configured so as to require a user action for operating the control, which is different from a user action required for operating each of the other controls,
wherein each of the plurality of controls is operable to perform a specific function for managing media.

2. The media control unit of claim 1, wherein the plurality of controls are co-located on a common housing.

3. The media control unit of claim 1, wherein each of the plurality of controls operates based on at least one of a rotating mechanism, a sliding mechanism, a push button mechanism, and a switching mechanism.

4. The media control unit of claim 1, wherein the specific function for managing media includes play, pause, skip-forward, skip-backward, volume control, rewind, fast-forward, and shuffle.

5. The media control unit of claim 1, wherein the user action required for operating each of the controls includes rotating, sliding, or pressing the control.

6. The media control unit of claim 1, wherein the plurality of controls are embodied as dedicated physical components for receiving user inputs.

7. The media control unit of claim 1, wherein the media player is one of an audio player, a video player, or both.

8. A method of controlling a media player in a portable communication device, the method comprising:
providing a plurality of controls dedicated to controlling the media player, wherein each of the plurality of controls is configured so as to require a user action for providing an input, the user action being different from a user action required by each of the other controls for providing an input;
receiving a user input at least one of the plurality of controls, wherein each of the plurality of controls is operable to perform a specific function for managing media; and
controlling the media player based on the received user input.

9. The method of claim 8, wherein the providing step includes: providing a user gesture including at least one of a rotating movement, a sliding movement, a push button movement, and a switching movement.

10. The method of claim 8, wherein the providing step includes: providing a touching user gesture including at least one of a rotating movement, a sliding movement, a push button movement, and a switching movement, for actuating at least one of play, pause, skip-forward, skip-backward, volume control, rewind, fast-forward, and shuffle.

11. A portable communication device comprising:
a media player;
a housing;
a media control unit located in the housing comprising,
a plurality of controls dedicated to controlling the media player by receiving user inputs,
wherein each of the plurality of controls is configured so as to require a user action for operating the control, which is different from a user action required for operating each of the other controls,
wherein each of the plurality of controls performs a specific function for managing media; and
a processor for receiving input signals from the media control unit and controlling the media player.

12. The portable communication device of claim 11, wherein the portable communication device is selected among a cellular phone, a two-way radio, a messaging device, a personal digital assistant, and a lap top computer.

13. The portable communication device of claim 11, wherein the media control unit is located on a lateral side of the housing.

14. The portable communication device of claim 11, further comprising a sensor arrangement for locking the media control unit.

15. The portable communication device of claim 14, wherein sensor arrangement includes at least one of an accelerometer, gyroscope, pressure sensor, and capacitance sensor for sensing a motion of the portable communication device.

16. The portable communication device of claim 11, wherein the portable communication device is one of a cellular phone, a portable digital assistance (PDA) device, and a handheld computing device.
